(19) United States
(12) Patent Application Publication
(10) Pub. No.: US 2002/0010635 A1
(43) Pub. Date: Jan. 24, 2002

(54) Method of electronic commerce and profile converter used for electronic commerce

(76) Inventor: Kazuhiro Tokiwa, Fukuoka (JP)

Correspondence Address: STAAS & HALSEY LLP, 700 11TH STREET, NW, SUITE 500, WASHINGTON, DC, 20001, US

(21) Appl. No.: 09/773,526

(22) Filed: Feb. 2, 2001

(30) Foreign Application Priority Data
Jul. 19, 2000 (JP) 2000-218690

(51) Int. Cl. G06F 17/60

(52) U.S. Cl. 705/26

(57) ABSTRACT

A method and system for electronic commerce that can prevent personal information (a real profile) from leaking to society. The electronic commerce system is structured in such a manner that a user transmits a transaction request, to which user ID information is added, to a shop system. The shop system then transmits a job order relating to the transaction request to a related business system together with the user ID information. The related business system then transmits requests conversion of the received user ID information to the real profile from a profile conversion system and the profile conversion system reads the real profile information corresponding to the user ID information from a database and transmits an answer to a business system related to the conversion request issuing source using encrypted communication and/or communication by a private line.

### CROSS REFERENCE TO RELATED APPLICATIONS

This application is based upon and claims priority of Japanese Patent Application No. 2000-218690, filed Jul. 19, 2000, the contents being incorporated herein by reference.

### BACKGROUND OF THE INVENTION

1. Field of the Invention

The present invention relates to electronic commerce and particularly to a method of electronic commerce to prevent leakage of personal information in a cyber mall to which many shops are registered.

2. Description of the Related Art

In recent years, electronic commerce using the Internet has rapidly spread. Particularly, a virtual mall has become very popular of late. In such a virtual mall, a virtual shopping district is formed in a virtual space formed on the Internet and an order of certain goods is issued to a shop in the virtual space based on manipulations by a user.

On the occasion of trading goods by such electronic commerce, it is often necessary to input a user's personal information to execute a credit transaction. Particularly, in order to transfer ordered goods to the user, information to identify the user (person or company) who has issued the order is inevitably necessary.

In some cases, due to an uncertain problem, the personal information exchanged through the Internet for such electronic commerce may be leaked and distributed for the purpose of an unwanted application. Particularly, if such personal information is handed over malicious others (company or person), such personal information may likely be used in a manner which is damaging, thus creating a social problem.

The main problems due to the leakage of personal information may be classified as follows:

(1) Name information: This information allows collation with the other information pieces, i.e., a list of telephone numbers, usage records of credit cards, hospital information, or the like, distributed about the relevant person based on the obtained personal name and may be used to merge such information.

(2) Telephone number: This information may result in damages such as prank phone calls.

(3) Address: This information may result in damages such as unwanted direct mailings or the like.

(4) E-mail addresses or the like: This type of information may generate damages resulting from SPAM mails, such as a mail bomb, virus mail and indecent information or the like.

(5) Credit card number: Criminal forging of credit card numbers and names often results from obtaining information pieces such as a credit card number and a personal name.

When these problems are taken into consideration, it is undesirable that personal and private information and information about credit cards are distributed on the Internet with its many security problems.

In the operation of the virtual mall explained above, it is desirable to gather many shops together. From a user's point of view, goods and services can be chosen from a wider selection, operators (providers, etc.) of the virtual mall can generate a large amount of revenue, such as commissions, and it is possible to expect an increase of users because of a higher level of convenience. Moreover, from the viewpoint of shop owners, if participation in the virtual mall is easy, it will be possible to expand business opportunities.

However, in the case where many shops participate in the virtual mall, the possibility that a malicious party will participate increases. Therefore, it is desirable to realize a higher level of security by preparing a more strict examination and contract conditions or the like. However, if examination and contract conditions are too strict, the threshold level for participation will increase resulting in a decrease in the number of participating shops. Moreover, as to the actual problems, it is very difficult to provide sufficient security to all of the many participating shops and doing so would cause an increase in cost.

### SUMMARY OF THE INVENTION

The present invention has been proposed considering the problems explained above and it is an object of the present invention to provide a method of electronic commerce which can prevent personal information (actual user profiles) from leaking to a society in which such electronic commerce is used.

The method of electronic commerce of the present invention has been proposed to solve the problems explained above and to realize electronic commerce through a process in which a shop system receives a goods/services transaction request transmitted by a user's system in which the shop system transmits a job order corresponding to the transaction request to a related business system. The method uses a profile conversion database for storing user ID information corresponding to each user and corresponding real profile information that is required by the related business system to execute the job corresponding to the transaction requested by the relevant user. Further, the profile conversion system is connected to the related business system to enable encrypted communication and/or communication with a private line.

The method further includes a first phase in which the user's terminal transmits a transaction request, together with corresponding user ID information, to a shop system. A second phase is also included in which the shop system transmits a job order corresponding to the transaction request that is associated with the user ID information to the related business system. A third phase is provided in which the business system transmits, to the profile conversion system, a request to convert the received user ID information to the real profile. A fourth phase is provided in which the profile conversion system reads the real profile information corresponding to the user ID information included in the received conversion request from the profile conversion database and sends a response to the related business system of the conversion request source through encrypted communication and/or a private line.

In above system, a user issues a transaction request using a user ID to the shop side in the first phase. This user ID does not include personal information (real profile) such as name, address, telephone number, E-mail address and credit card number. The user ID is used as the ID for searching the real profile in a database explained below.

In the second phase, the shop system that has received the transaction request requests the job corresponding to the transaction request relays the transaction to the related business system. The “related business” corresponds to processes such as distribution of goods to be traded, communication with a user and settlement or the like. Therefore, the related business system could be installed in the post office and distribution company for distributing the goods ordered from the shop system, a provider and telephone company for communication with the user and a bank or credit card company for payment purposes. Moreover, when the request is relayed to the business system, the user ID of the user who has issued the request is informed.

In the third phase, the related business system transmits a request to convert the received user ID to the real profile in the profile conversion system and, in the fourth phase, the profile conversion system searches the database and transmits the real profile to the related business system as the request issuing source.

The institute that executes the related business executes the job related to the relevant transaction based on the returned real profile.

With the structure explained above, a virtual shop does not directly know the real profile of the user as a request issuing source and only the institute where the related business system is installed actually knows the real profile of the user. In the case where the contract to protect the real profile is agreed upon, through sufficient examination with the institute where the related business system is installed, only a creditable institute can know the real profile and the risk for leakage of the real profile (personal information) can be reduced remarkably.

Moreover, the profile conversion system relays the real profile through encrypted communication and/or communication with a private line, i.e., a secure communication, and, thereby, the risk of leaking the real profile on the network can also be eliminated.

It is preferable that the present invention is adapted to a system where the cyber mall system is provided to realize a system in which virtual shops corresponding to the shop system are provided. In this case, in the first phase, the transaction request is transmitted to a virtual shop on the cyber mall system from the user system and the cyber mall system transmits the transaction request to the shop system corresponding to the virtual shop that has received the transaction request.

Moreover, the cyber mall system provides a virtual mall in which a virtual person corresponding to a user is assumed to move in the virtual space and enter a virtual shop provided in the virtual space to request a transaction and, when the user ID information is assumed as the virtual profile as the personal information of the virtual person corresponding to the user, if the virtual profile were leaked, adequate measure may be easily taken by changing such virtual profile.

Moreover, since the shop system provides that the real profile is not directly notified thereto, severe examination and contracts are not required for a shop system to participate in the cyber mall and participating shops may be selected from a wider range.

Moreover, since the shop system issues an inquiry to the profile conversion system to determine whether the real profile corresponding to the user ID included in the transaction request received in the first request is stored in the database, the profile conversion system sends a response to the shop system as the inquiry issuing source to determine whether the real profile corresponding to the user ID exists by searching the database based on the inquiry. The shop system then executes, upon receiving a response indicating whether the real profile exists, the second phase of the process. However, the second phase of the process is not executed if a response indicating that the real profile does not exist is received. The shop side can issue an order corresponding to the job after checking that the real profile corresponding to the user who has placed issued the order exists, thereby preventing a useless job order from being placed.

Accordingly, the profile converter transmits a response indicating whether the real profile exists to the shop system and does not directly transmit the real profile itself, thereby preventing leakage of the real profile.

The second phase explained above is not always required to transmit the order information using the communication line to the related business system from the shop system and it is also possible for the shop system to record the order information and user ID on a computer readable medium and the related business system can read the order information and user ID from the storage medium.

This computer readable medium may be substituted, for example, with an electronic slip having a memory function. Moreover, it is also possible to print a barcode or a format that can be read with OCR on a paper medium and this medium can be read with a barcode or OCR reader provided on the related business system side. With such a structure, the virtual profile can be transmitted to the related business system side.

Moreover, it is preferable that the profile conversion system stores the real profile information that is necessary for each related business system and the fourth phase is structured so that the profile conversion system authenticates the related business system of the conversion request issuing source and only the real profile information relating to the relevant related business system is relayed to the related business system as the conversion request issuing source, and only the minimum real profile information is relayed to the related business system. For example, the address information is notified to the goods distribution company but credit card information is not. Thereby, potential damage can be minimized even if the real profile is illegally leaked to the related business system side.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of the structure of an embodiment of the present invention.

FIG. 2 is an example of data stored in the profile conversion database according to an embodiment of the present invention.

FIG. 3 is a diagram showing an example of the distribution process according to an embodiment of the present invention.

FIG. 4 is a diagram showing an example of the communication process according to an embodiment of the present invention.

FIG. 5 is a diagram showing an example of the settlement process according to an embodiment of the present invention.

### DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

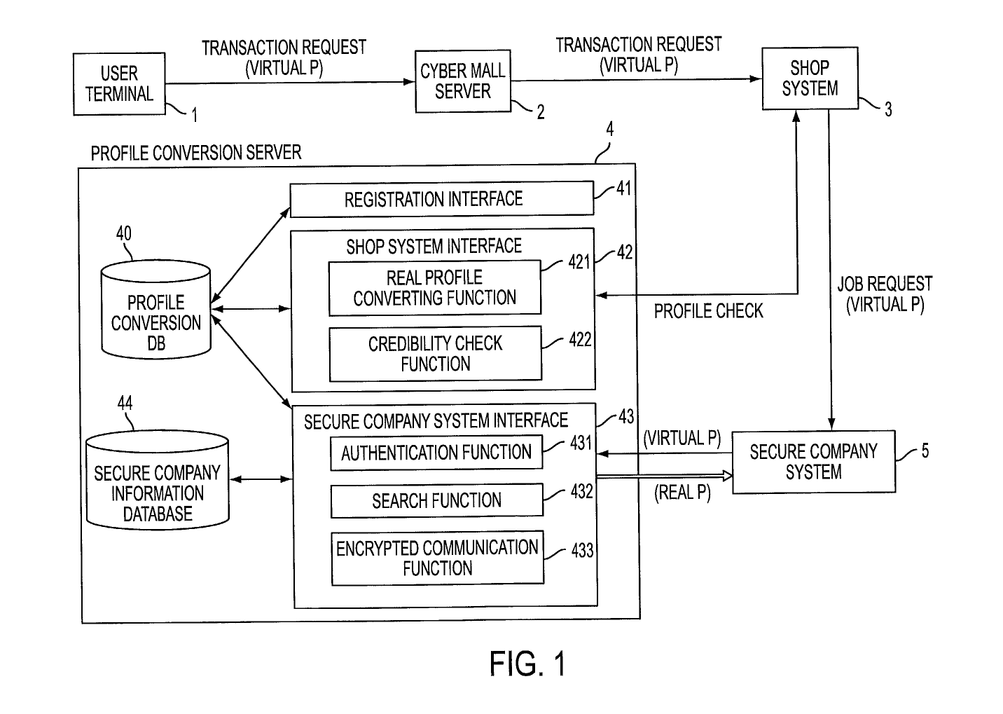

FIG. 1 is a block diagram illustrating the total structure of the electronic commerce system of the present invention. In this diagram, an example of a transaction using the cyber mall to execute the transaction by making use of the shops provided in the virtual space is illustrated.

In this figure, numeral 1 designates a user terminal used by the user side to order a transaction in the cyber mall. Numeral 2 designates a cyber mall server for providing cyber mall services and numeral 3 represents a shop system to be installed in virtual shops participating in the relevant cyber mall.

The cyber mall server 2 transmits the transaction order received by the virtual shop to the shop system. In this embodiment, it is assumed that the cyber mall forms a shopping district in virtual space. A previously registered virtual person enters a virtual shop in the shopping district in the virtual space depending on the instruction issued from the corresponding user terminal 1 and issues the transaction order by obtaining information about goods and services in this virtual shop. Since the means itself for realizing such a cyber mall using virtual space is already known, a detailed description thereof is omitted here.

Numeral 4 designates a profile conversion server comprising a profile conversion database 40 for storing the real profile as the actual personal information and the corresponding virtual profile as the personal information of a virtual person. A secure company information database 44 is provided for authenticating a secure company system (explained later), storing the real profile information allowed to be provided to the secure company system and storing the encrypted information for connecting with the secure company system 5.

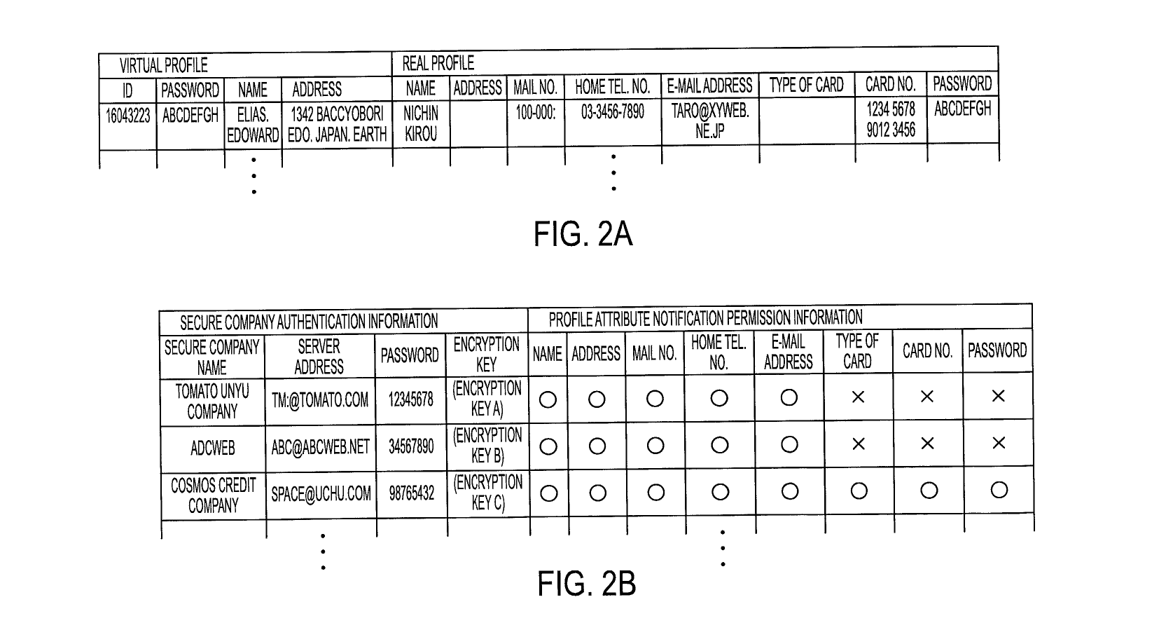

An example of the information to be stored in the profile conversion database 40 is illustrated in FIG. 2(a). The virtual profile includes an ID, a password, a name in the virtual space and an address on the virtual space. Meanwhile, the real profile includes a personal name, address information (address, mail number), communication information (telephone number, E-mail address, etc.) and settlement information (type of card, card number and password of card).

A secure company information database 44 is used, as illustrated in FIG. 2(b), to store, corresponding to the secure company name, address information for authenticating the secure company system 5, a password, secure company authentication information including encryption key information for encrypted communications and corresponding profile attribute notification permitting information for setting, with a flag, whether the offering of the relevant secure company system 5 is permitted for every attribute of the real profile registered to the profile conversion database 40 (permitted notification is indicated with “O”, while non-permitted notification with a “X”).

Moreover, the profile conversion server 4 comprises a registration interface 41 for registering the real profile and corresponding information in the virtual space to the profile management database 40 based on a request from the user terminal 1, a shop system interface 42 for executing a process corresponding to an inquiry from the shop system 3 and a secure company system interface 43 for executing the process based on the conversion request from the secure company system 5, explained later.

The shop system interface 42 is provided with a real profile confirming function 421 to check whether the real profile corresponding to the virtual profile included in the inquiry from the shop system 3 exists in the profile conversion database 40 and a credibility check function 422 for checking credibility by the financial institute based on the settlement information of a credit card included in the profile.

Moreover, the secure company system interface 43 is provided with an authentication function 431 for authenticating a terminal on the secure company side that has transmitted a conversion request, a search function 432 for searching the profile conversion database 40 based on the authenticated conversion request and reading the real profile corresponding to the virtual profile included in the conversion request and an encrypted communication function 433 for encrypting the answer information including the real profile using encryption corresponding to the secure company system 5 as the request issuing source to send a response. Each function will be executed, as will be explained later, by referring to the information stored in the secure company information database 44.

The cyber mall server 2 and profile conversion server 4 are generally operated by an operator (provider) which provides the services. Therefore, from the viewpoint of hardware, functions of both servers may be realized by the same apparatus and, moreover, may be realized by independent apparatuses that are independent from each other from both the physical and logical viewpoints.

Numeral 5 designates a secure company system. This system corresponds to the “related business system” and is installed by the company to execute related jobs for goods and/or services dealt with by the virtual shop. This “related job” includes, as will be explained, goods distribution jobs for users, a communication job, a settlement job or the like. Moreover, the company for this related job executes the job by obtaining the user's real profile and, therefore, it is preferable for this company to agree to a contract promising to protect the real profile with the operation side of the profile conversion server 4. In addition, in view of preventing the real profile from leakage, the communication path for the profile conversion server 4, particularly the communication path to transmit the real profile to the secure company system 5 from the profile conversion server 4 is formed to conduct an encrypted communication and/or a communication with a private line.

In the figures following FIG. 1, the communications for which information leakage should be prevented using encrypted communications are illustrated with a double-line (the encrypted communication is also assured for the other communications but the communications indicated with a double-line require particular secrecy as the subject matter of the present invention).

In each figure following FIG. 1, <virtual P> indicates that the virtual profile is included in the information to be communicated and <real P> indicates that the real profile is included in the information to be communicated.

In actuality, a plurality of user terminals 1, shop systems 3 and secure company systems 5 are used (a plurality of users, shops and secure companies participate), but only one unit of these elements is respectively illustrated in FIG. 1 to simplify the drawings. Moreover, although not particularly restricted, the Internet is generally used for the communications for which the communicating means is not particularly explained.

Next, an embodiment of electronic commerce using the electronic commerce system explained above will be explained.

To store information in the profile conversion database 40, a user of the electronic commerce system of the present invention previously assures correspondence between the virtual profile and the real profile and then stores these profiles in the profile conversion database 40 using the profile registration interface 41. For this information storing, it is also possible to introduce a structure in which the information storage request is transmitted directly to the profile conversion server 4 from the user terminal 1. However, transmission of all real profiles by the Internet results in many security problems.

Therefore, it is preferable in such a structure that a user relays the information storage request to the provider of the cyber mall server 2 by a method such as mail, which does not easily leak personal information. The provider checks whether information storage is reasonable for the user as the request issuing source (whether settlement by deposition at the bank or use of credit card is possible), when information storage registration is reasonable, the virtual profile in the virtual space provided by the cyber mall system 2 is generated (all or a part of this virtual profile may be generated directly by the user), and information is stored by the cyber mall system 2 and the profile conversion server 4 is requested to store the information.

It is also possible that tentative registration of a user is made first through the Internet and the important information of the real profile is stored later with a final registration using a mail system.

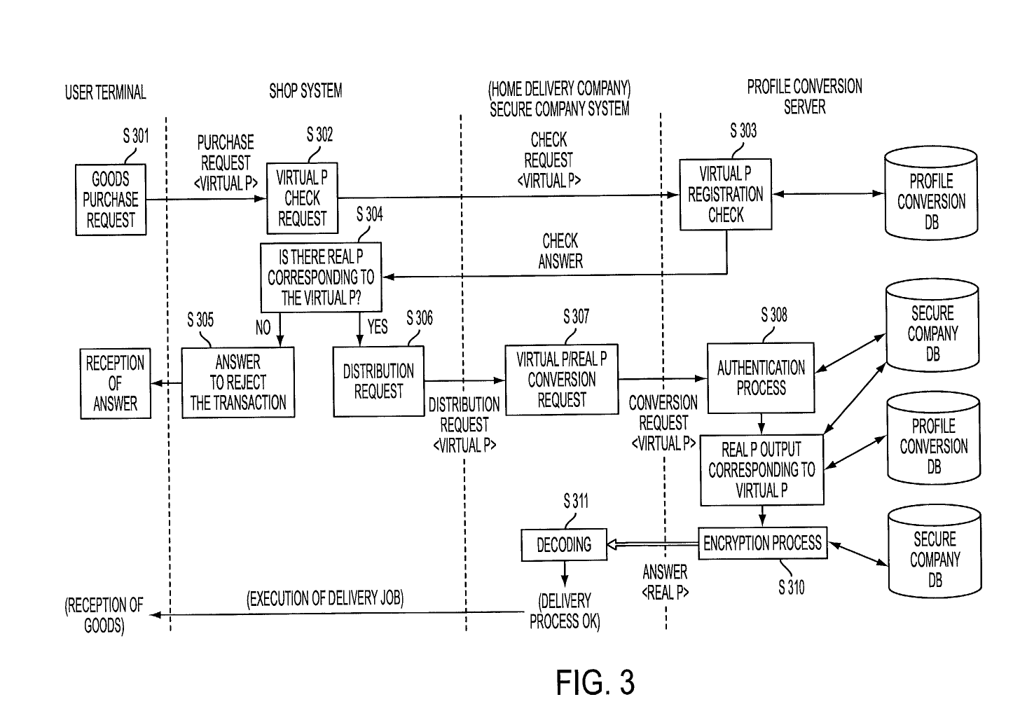

Referring to the flowchart of FIG. 3, the distribution process (process to distribute the goods ordered to the shop system to users) according to the present invention will now be explained. Here, the secure company system 5 is installed by the company for goods distribution such as a home delivery company or the post office. In this embodiment, such a company is designated as the “Tomato Unyu Company”. In this figure, the cyber mall system 2 is not illustrated.

First, a user transmits an order of goods to the shop system 3 from the user terminal 1 (S301). In more practical terms, the user accesses the cyber mall system 3 with the user terminal 1 to send the order of goods to the virtual shop in the cyber mall. The cyber mall system that has received this order transfers this order to the shop system corresponding to the virtual shop. For issuance of this order, it is also possible to add the virtual profile of the user to the order information from the user terminal 1 and, moreover, to add, as the virtual profile, the information about the virtual person in the virtual space in the cyber mall system side to the order information. In addition, the order information may be transferred to the shop system 3 on a real-time basis in the cyber mall system 2 having received the order. Moreover the orders are accumulated for a certain period and a plurality of orders may be transferred at one time to the shop system.

The shop system 3 that has received the order information to which the virtual profile is added issues an inquiry to the profile conversion server 4 to determine whether there is a real profile corresponding to the relevant virtual profile to check whether the transaction using the received virtual profile is possible (S302).

The shop system interface 42 of the profile conversion server 4 that has received this inquiry accesses the profile conversion database 40 to check for the existence of the real profile corresponding to the received virtual profile and then transmits an answer indicating whether the real profile exists to the shop system 3 as the request issuing source (S303). Here, the existence or non-existence of the real profile is relayed and the real profile itself is not.

When an answer indicating that the real profile does not exist is returned, the shop system 3 rejects the transaction (S304) and notifies this to the user (S305).

Meanwhile, when an answer indicating the existence of the real profile cannot be obtained, the shop system 3 issues the goods delivery request by adding the virtual profile of the transaction request issuing source to the secure company system 5 installed at the “Tomato Unyu Company” (S306).

This delivery request may also be issued with a communication to the secure company system 5 from the shop system 3 and, moreover, the request information adding the virtual profile is recorded on a computer readable medium and this medium is added to the goods or transmitted separately as a slip. As the computer readable medium, an electronic slip having a memory function and a paper medium on which a barcode or characters that can be read with OCR are printed may be used. When this method is introduced, a recording apparatus to record the information on these media is provided to the shop system 3 and a reader to reach the information stored in these media is provided to the secure company system 5.

The secure company system 5, having received the delivery request, issues a request to convert the virtual profile and real profile to the secure company interface 43 of the profile conversion system 4 (S307).

The authentication function 431 of the secure company interface 43 authenticates the secure company system 5 of the request issuing source on the basis of the information stored in the secure company database 44 and does not send an answer about the real database if the request is not issued from an authorized secure company system (S308).

On the other hand, when the authorized secure company system is authenticated, the search function 43 accesses the profile conversion database and outputs the real profile corresponding to the received virtual profile (S309). Since the secure company system 5 authenticated in S308 belongs to the “Tomato Unyu Company”, the search function 432 transmits the name and address information pieces based on the profile attribute notification permitting information stored in the secure company database 44 (refer to FIG. 2(b)), but does not transmit the credit card information or the like.

The encrypted communication function 433 encrypts the answer information including the real profile based on the encryption key information corresponding to the secure company system 5 of the request issuing source stored in the secure company database 44 and then transmits the encrypted answer information to the secure company system 5 of the request issuing source (S310).

The secure company system 5 decodes the answer information to read the real profile information (S311). The “Tomato Unyu Company” having the secure company system 5 starts the delivery of goods requested from the shop system 3 using the information included in this real profile, for example, the address and mail number.

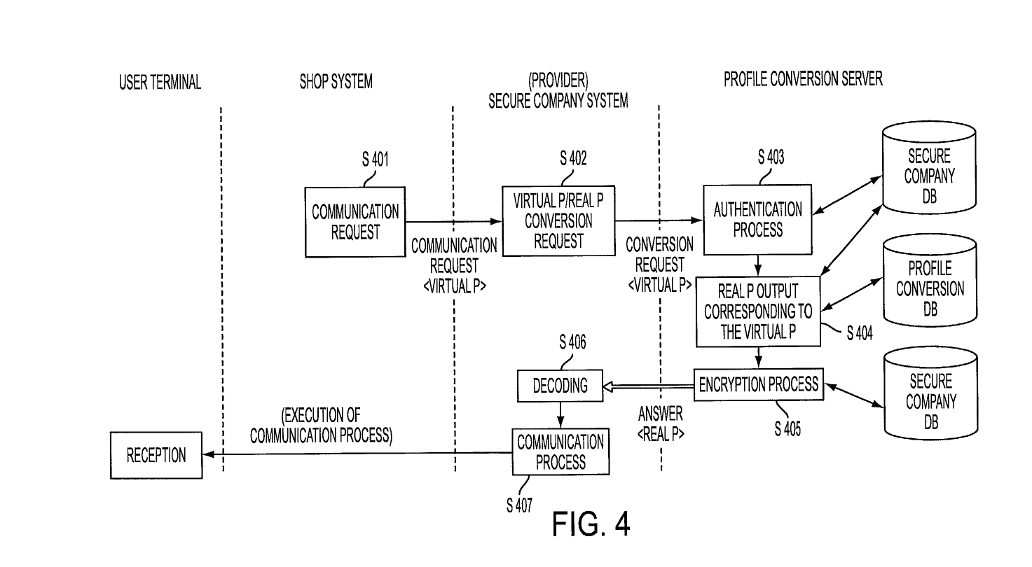

FIG. 4 is a diagram for explaining the process of communication, such as notice and inquiry, to the user who has issued the transaction request by the shop system 3 according to an embodiment of the invention.

In the present invention, the shop on the side of shop system 3 cannot know the real profile of the user who has issued the transaction request and, therefore, cannot make direct contact with the user.

Therefore, the communication is set up via communication companies, such as a telephone company, provider or the like registered as the secure company. In this embodiment, this company is defined as the provider “abcweb”.

The basic process is same as the delivery process explained above. First, the shop system 3 transmits the virtual profile and the information including the communication information to the secure company system 5 installed, for example, at “abcweb” as the secure company (S401).

The secure company system 5 of “abcweb” having received this virtual profile requests the real profile from the secure company interface of the profile conversion server 4 (S402).

Upon receiving this request, the secure company interface 43 executes, as in the process shown in S308 to S3 10, authentication by an authentication function 431 (S403), a process (S404) by a search function 432 to output the real profile corresponding to the virtual profile received from the profile conversion database 40 and a process (S405) by an encrypted communication function 433 to encrypt the answer information, which includes the real profile, with the encryption key information corresponding to the secure company system 5 of the request issuing source and transmits the encrypted information to the secure company system 5 of the request issuing source.

In the S404, the credit card information is not transmitted to “abcweb” on the basis of the registration information of the secure company database 44 (refer to FIG. 2(b)).

The secure company system 5 decodes the answer information and reads the real profile information (S406). “abcweb”, having the secure company system 5, transmits the received communication contents to the user according to destination information such as an E-mail address or the like, which is included in the received real profile (S407).

In this communication process, an example of an E-mail distribution process is considered but this process can also be adapted to a telephone exchange service in an alternative embodiment. In this case, the telephone company becomes the secure company. For example, the telephone number having 12 digits is set as the user ID and when the telephone number of 12 digits is input, the telephone company side requests conversion of this telephone number to the corresponding telephone number information included in the real profile as the virtual profile for the profile conversion database and then connects the converted telephone number information to the obtained (real) telephone number information. With this structure, the shop system side can issue a call to the users even if the shop system does not have the user's telephone number.

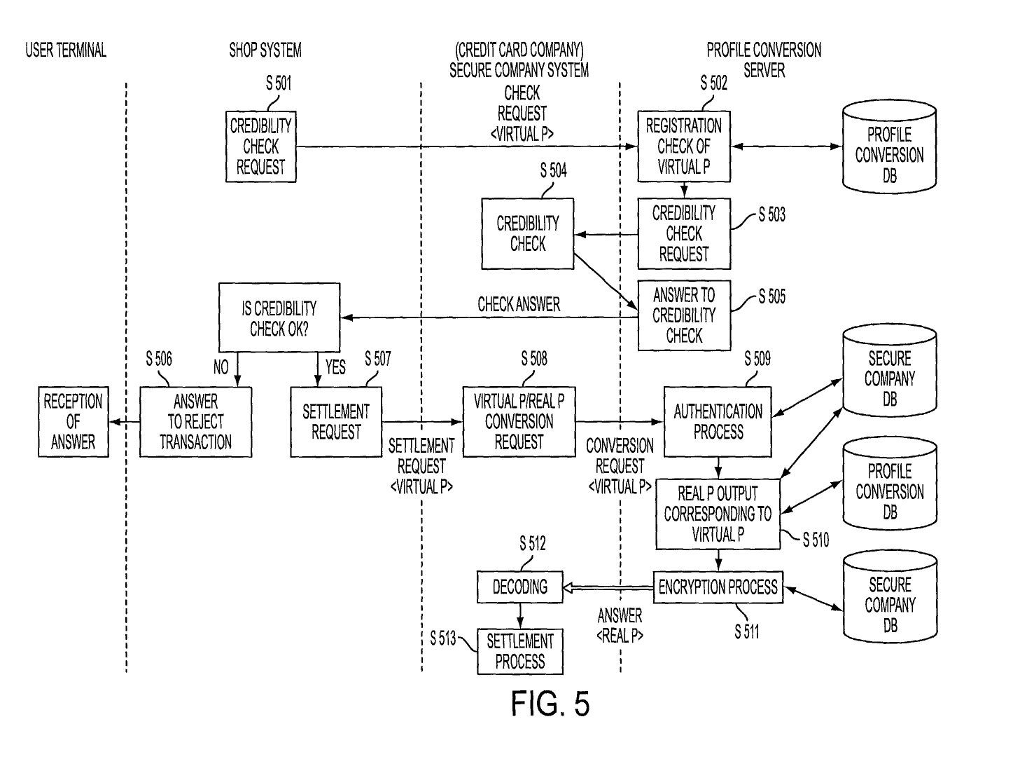

FIG. 5 is a diagram for explaining the process to settle a transaction request using a credit card according to an embodiment of the invention.

In this embodiment, settlement is conducted without direct transmission of personal information, including a credit card number, to the shop on the shop system 3 side. Here, the credit company for the settlement is registered as the secure company and is provided with the secure company system 5. In the embodiment, the credit card company is designated as “Cosmos Credit Company”, for example.

The shop system 3 transmits a credit check request, including a virtual profile of a user, to the shop system interface 42 of the profile conversion server 4 (S501). The credit check function 422 of the shop system interface 42 first checks whether the requested type of credit exists by accessing the profile conversion database 40 (S502). When such credit exists, the credit check request, including the password and card number corresponding to such credit card, is transmitted to the credit card company corresponding to the type of card (S503).

The secure company system 5 of the “Cosmos Credit Company” as the credit card company that has received this request returns an answer to the profile conversion server 4 to indicate whether credibility is sufficient by checking the type of credit card, the card number and the password received (S504). The credit check function 422 sends the received result to the shop system (S505). In exchange for such pieces of information, it is preferable to maintain secrecy to prevent leakage of credit card information through the encrypted communication.

If settlement is impossible as a result of the credit check, the shop system 3 sends a settlement rejection to the user terminal 1 (S506). When settlement is possible, the shop system 3 sends a payment request, including the virtual profile, to the secure company system 5 provided in the credit card company (S507).

The secure company system 5 of the “Cosmos Credit Company” having received this virtual profile asks the secure company interface 43 of the profile conversion server 4 (S508) for the real profile.

The secure company interface 43 having received this request executes, as in the process indicated in S308 to S310, authentication by an authentication function 431 (S509), a process by the search function 432 to output the real profile corresponding to the virtual profile received from the profile conversion database 40 (S510) and a process by the encrypted communication function 433 to encrypt the answer information, including the real profile, with the encryption key information corresponding to the secure company system 5 of the request issuing source and then transmits this encrypted information to the secure company system 5 of the request issuing source (S511).

In an output of the real profile in the S510, since the card information notification permission is stored for the “Cosmos Credit Company” in the secure company database 44 as illustrated in FIG. 2(b), the search function also outputs the card information.

The secure company system 5 decodes the answer information and reads the real profile information (S512). The “Cosmos Credit Company”, having the secure company system 5, transmits the received communication contents to the user using the credit number included in the received real profile.

According to the embodiment explained above, the shop system 3 can detect the profile in the user's virtual space when the user has issued a transaction request but cannot access the real profile including the user's personal information. The leaked virtual profile can be changed easily (for example, change of name of the virtual person in the virtual space, change of telephone number and change of address due to moving can be easily realized). Since profile change if the real profile is leaked (change of name, change of telephone number and change of address due to moving) is not easy, the real profile is revealed only to the company that has sufficient capability to keep the information secure and a job that requires the use of the real profile during the electronic commerce is shared only to such company. Thereby, the risk of leaking the real profile can be reduced remarkably.

As explained above, the method of electronic commerce of the present invention can remarkably reduce the risk of leaking the real profile because the company that can keep the information secure can execute the job which requires such personal information (real profile) about the user for the electronic commerce and the shop that has received the transaction request cannot obtain the real profile of the user.

What is claimed is:

1. An electronic commerce system in which a shop system receives a goods/service transaction request transmitted by a user terminal and the shop system transmits a business order relating to the transaction request to a related business system, comprising:
a profile conversion database storing a user ID that is set for each of a plurality of users and corresponding real profile information that is required by the related business system to execute a job corresponding to the transaction request; and
a profile conversion system connected to said related business system to enable a secure communication, wherein
the user terminal transmits the transaction request with the corresponding user ID the shop system, the shop system transmits a job order relating to the transaction request with the user ID to the related business system, the related business system transmits, to said profile conversion system, a request to convert the received user ID to the real profile information and said profile conversion system reads the real profile information corresponding to the user ID and sends a response to the related business.

2. The electronic commerce system as claimed in claim 1, further comprising a cyber mall providing virtual shops corresponding to the shop system and the transaction request is transmitted to the virtual shops in said cyber mall system from the user terminal and said cyber mall transmits the transaction request to the shop system which has received the transaction request.

3. The electronic commerce system as claimed in claim 2, wherein said cyber mall provides a virtual mall in which a virtual person corresponding to the user moves in the virtual mall and enters a virtual shop provided in the virtual mall to issue the transaction request and the user ID is a virtual profile containing personal information about the virtual person.

4. The electronic commerce system as claimed in claim 1, wherein
the shop system issues an inquiry, to said profile conversion system, to determine whether the real profile information corresponding to the user ID included in the transaction request received is stored in said profile conversion database;
said profile conversion system sends a response to the shop system as an inquiry issuing source, to determine whether the real profile corresponding to the user ID exists by searching the profile conversion database; and
the shop system transmits the job order relating to the transaction request to the related business system if a response indicating that the real profile exists is received by the shop system.

5. The electronic commerce system as claimed in claim 1, wherein the shop only upon receiving a response indicating that the real profile exists records order information and the user ID to a computer readable medium and the related business system reads information, and the user ID from the computer readable medium.

6. The electronic commerce system as claimed in claim 1, wherein said profile conversion system stores the real profile information which is allowed to be served for the related business system, authenticates the related business system as the conversion request issuing source and transmits only the real profile information which is allowed to be served to the related business system as the conversion request issuing source.

7. A system comprising:
a profile converter used in electronic commerce to receive, with a shop system, a goods/service transaction request transmitted from a user system and to transmit a job order corresponding to the goods/service transaction request from the shop system to a related business system, wherein said profile converter is connected to the related business system to enable communication with at least one of encryption and a private line; and
a profile conversion database to store a user ID set for each of a plurality of users and real profile information respectively corresponding to each user ID, the real profile information being required by the related business system to execute the job order, wherein
the real profile information is read when the request from said related business system to convert the user ID to the real profile information is received from said profile conversion database and a response is returned to the related business system as a conversion request issuing source.

8. A method comprising:
transmitting, from a user terminal to a shop system, a transaction request and a user ID corresponding to a user of the user terminal;
transmitting, from the shop system to a related business system, a job order corresponding to the transaction request;
transmitting, from the related business system to a profile conversion system, a request to convert the received user ID information to a real profile, the real profile corresponding to the user ID and being stored in a database of the profile conversion system; and
transmitting, from the profile conversion system to the related business system, the real profile corresponding to the user ID of the user.

9. The method as claimed in claim 8, wherein the real profile is transmitted to the related business system via at least one of encrypted communications or communication via a private line.

10. The method as claimed in claim 8, wherein the transaction request and the user ID are transmitted to the shop system from the user terminal via a virtual shop in a cyber mall system, wherein the virtual shop receives the transaction request and the user ID from the user terminal and transmits the transaction request and the user ID to the shop system.

11. The method as claimed in claim 10, wherein the cyber mall system includes a virtual mall in which a virtual person corresponding to the user enters the virtual shop to make the transaction request.

12. The method as claimed in claim 8, wherein the real profile is not transmitted to the shop system.

13. The method as claimed in claim 8, wherein the shop system transmits an inquiry to the profile conversion system to determine whether the real profile corresponding to the user ID, which was transmitted with the transaction request from the user terminal, is stored in the database.

14. The method as claimed in claim 13, wherein the shop system transmits to the related business system the job order corresponding to the transaction request if a response indicating that the real profile corresponding to the user ID is stored in the database is received by the shop system.

15. The method as claimed in claim 13, wherein the shop system does not transmit the job order corresponding to the transaction request to the related business system if the shop system does not receive a response indicating that the real profile corresponding to the user ID is stored in the database.

16. The method as claimed in claim 8, wherein the shop system records the transaction request and the user ID on a computer readable medium and the related business system reads the job order and the user ID from the computer readable medium.
